(19) United States
(12) Patent Application Publication
(10) Pub. No.: US 2006/0110310 A1
(43) Pub. Date: May 25, 2006

(54) Systems and methods for reducing carbonates in a chlorination system

(75) Inventor: Tommy J. Shane, Loganville, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Tomco2 Equipment Company

(21) Appl. No.: 10/994,109

(22) Filed: Nov. 19, 2004

(51) Int. Cl. C01B 11/04

(52) U.S. Cl. 423/473; 422/105; 422/224

(57) ABSTRACT

Systems and methods are disclosed for increasing the concentration of hypochlorous acid in a quantity of water. Acid is added into chlorinated water to decrease the pH of the chlorinated water. By decreasing the pH, the hypochlorite/hypochlorous acid equilibrium of the chlorinated water is shifted to increase the concentration of hypochlorous acid on the treated water and the tendency for precipitation of solids such as carbonates is reduced. A portion of the chlorinated solution can be continuously returned to a mixing tank under pressure.

### BACKGROUND

1. Field of the Present Disclosure

This disclosure relates generally to the field of chlorinating systems, and relates more specifically to methods and systems for producing hypochlorous acid solutions and maintaining hypochlorous acid concentrations by manipulating the pH of the solution. In particular, this disclosure relates to the reduction of the formation of carbonates in such systems.

2. Background of the Present Disclosure

Chlorination is a known method for killing undesirable microorganisms. Chlorine can be provided in multiple forms including chlorine gas (Cl₂), sodium hypochlorite liquid, calcium hypochlorite powder or granules, or isocyanuric acids. Chlorine gas (Cl₂) is a relatively cheap and highly effective antimicrobial agent; however, it is also a highly toxic and corrosive gas. Hypochlorites such as sodium hypochlorite (NaOCl) or calcium hypochlorite (Ca(OCl)₂) are a safer alternative, but are considerably more expensive than gaseous chlorine. Finally, hypochlorite solutions (i.e., bleach) may also be utilized, however these are rarely used in large scale water treatment applications because they are bulky and expensive. Regardless of the chlorine source, hypochlorous acid (HOCl) and the hypochlorite ion (OCl⁻) are the final desirable antimicrobial products.

One method of forming HOCl occurs when Cl₂ is dissolved in water. The reaction proceeds according to the following equation:
Cl₂+H₂O [symbol] HOCl+H⁺+Cl⁻ (1)

Another method for producing HOCl uses metal hypochlorites dissolved in water. The reaction proceeds according to the following exemplary equation:
NaOCl+H₂O [symbol] NaOH+HOCl (2)

This method is generally utilized by common household hypochlorites and generates HOCl on a relatively small scale.

HOCl is a weak acid and will dissociate. In aqueous solution, HOCl and OCl⁻ are generally present in a pH dependent equilibrium:
HOCl [symbol] H⁺+OCl⁻ pKa=7.53 (3)
At low pH, HOCl is the predominant form, while at high pH, OCl⁻ predominates. The HOCl form is about 80 times more effective than OCl⁻ for killing microorganisms because HOCl crosses cell membranes easier than the hypochlorite ion. Accordingly, it would be desirable to control the pH of the chlorinated solution to increase the antimicrobial effectiveness of the chlorination process.

Processes and systems for dissolving chlorine in water are known in the art. For example, U.S. Pat. No. 6,228,273 to Hammonds discloses an apparatus and method for controlling the rate of dissolution of solid chemical material into solution, in particular, the dissolution of calcium hypochlorite. This patent discloses a water tank that receives a source of fresh water and a chlorination column filled with granules or tablets of, e.g., calcium hypochlorite. Perforations in the column allow water in the tank to fill the column at substantially the same level as that of the tank. The column is filled with tablets or granules to a level that extends above the level of water in the tank so that as the tablets erode, more tablets are lowered by gravity and sink into the liquid of the tank. This system has drawbacks. In particular, if make up water with a pH of 8.3 or greater or if carbonic acid is present in the hypochlorite solution, then there is a tendency for formation and precipitation of carbonate residues that can be undesirable. Thus, there is a need for a system for forming hypochlorous acid solution that reduces or prevents the precipitation of carbonates in the system.

### SUMMARY

The present disclosure relates to a chlorinating system for dissolving chlorine in water to form hypochlorous acid. One exemplary embodiment of the disclosed methods includes steps of introducing an acid solution into a chlorinating tank, the acid solution having a pH of less than 7 and greater than about 5.5, combining the acid solution with a chlorinating agent to form a hypochlorous acid solution, and controlling the amount of the acid solution introduced into the chlorinating tank to bring the pH of the combined hypochlorous acid solution to less than about 6.5.

One exemplary system of the disclosed systems includes a line configured to deliver acid solution into a chlorinating tank, the acid solution having a pH of less than 7 and greater than about 5.5, a chlorinating tank, wherein the acid solution is combined with a hypochlorite disposed in the chlorinating tank to form a hypochlorous acid solution, and a control system configured to control the amount of the acid solution introduced into the chlorination system to bring the pH of the hypochlorous acid solution to less than about 6.5.

These and other objects, features, and advantages of the disclosed systems and methods will become more apparent upon reading the following specification in conjunction with the accompanying drawing figure and claims.

### BRIEF DESCRIPTION OF THE DRAWING

Aspects of the disclosed systems and methods can be better understood with reference to the following drawing. The components in the drawings are not necessarily to scale.

FIG. 1 is a flow diagram of a representative embodiment of a chlorination system of the present disclosure.

### DETAILED DESCRIPTION

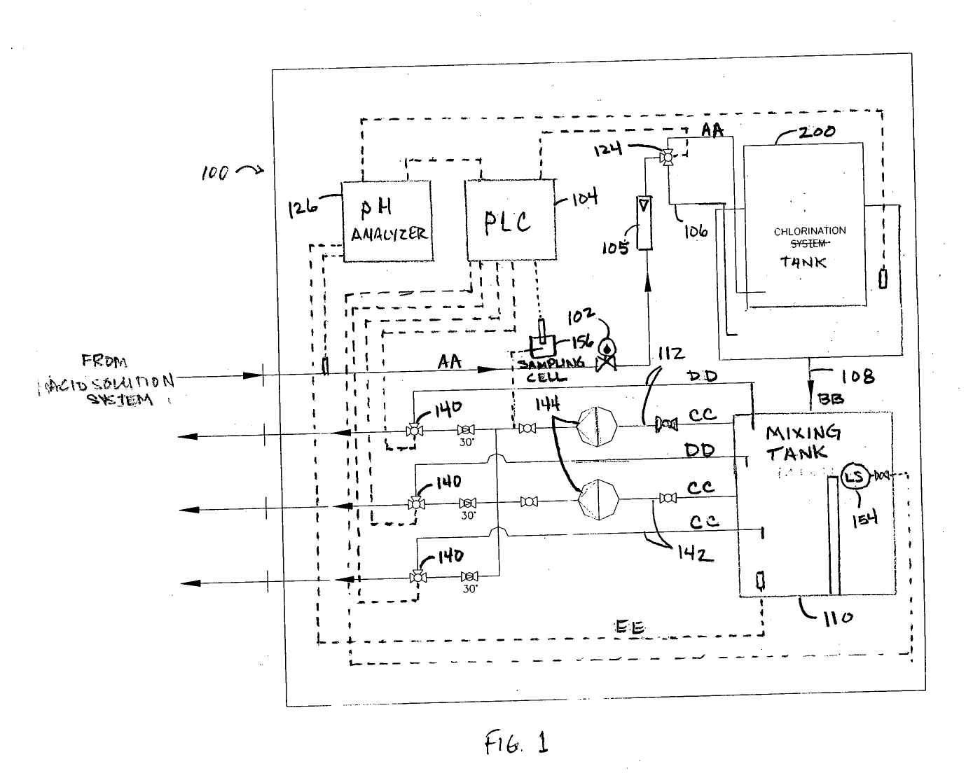

Referring now to FIG. 1, depicted is a general schematic of an exemplary embodiment of a chlorination system 100. The various components are connected using standard piping. The process of the present system can be performed at ambient temperature or lower, i.e., about 25° C. or less.

As shown in FIG. 1, a stream of acidified make up water AA is directed from a water source to chlorination system 100. Stream AA is typically from a carbonic acid system or other acid system then pumped at a slightly higher pressure than normal line pressures. Stream AA flows through shut-off valve 102, and then through flow meter 105. Valve 102 can be either an automatic solenoid valve or a manual isolation valve. The total flow rate of acidified make up water stream AA is controllable by, for example, the operation of a metering control valve 124 in response to signals from a Programmed Logic Controller (PLC) 104 which coordinates the overall system operation. A line 106 can split a portion of make up water stream AA providing greater control of the fluid volume in the chlorination tank 200. The remainder of make up water stream AA enters tank 200 and is subjected to chlorination therein by the addition of a chlorinating agent. The chlorinating agent may be a chlorine gas, a solid hypochlorite salt (e.g., NaOCl or Ca(OCl)₂), a liquid hypochlorite solution (i.e., a bleach), or isocyanuric acid. The chlorinating agent serves to raise the concentration of chlorine in make up water stream AA by the hypochlorite ion (OCl⁻), hypochlorous acid (HOCl), or a combination thereof. In one embodiment, the chlorinating agent is a metal hypochlorite, such as, for example, but not limited to NaOCl₂ or Ca(OCl)₂.

An exemplary chlorination tank is that disclosed in the aforementioned U.S. Pat. No. 6,228,273 to Hammonds employing a perforated chlorination column disposed within a water tank, which patent is incorporated by reference as if fully set forth herein. When using the system of this patent, the acidified make up water stream AA is designed to wash over at least a portion of the perforated chlorination column and line 106 is diverted directly into the water tank, bypassing the chlorination column.

Stream AA exits the chlorination tank 200 as chlorinated stream BB through line 108 directed to a holding or mixing tank 110. The mixing tank 110 functions to complete the mixing of the acidified make up water with the chlorinating agent. The mixing tank can provide the mixing function through pumps 144, which increase the pressure of chlorinated water stream CC exiting the mixing tank 110. Where the hypochlorous acid solution is ultimately delivered to a pressurized feed solution system such as that disclosed in co-pending U.S. application Ser. No. 10/050,491, the pressure is preferably at least about 50 psi. In an exemplary embodiment, the pumps are oversized, providing more pumping capacity than needed. Excess chlorinated water stream CC flowing from the mixing tank 110 under increased pressure can return to the mixing tank 110 via return lines 112 as water streams DD. In an exemplary embodiment, valves 140, such as V-notch valves, control the amount of chlorinated water stream DD to process. Excess chlorinated water not needed for the process is returned to the mixing tank 110. As an example, 1 to 10 gallons per minute (gpm) of each excess chlorinated water stream DD can be returned to mixing tank 110. Valves 140 can be controlled by PLC 104 to control the amount of chlorinated water to process. The increased water pressure from water streams DD returned back to mixing tank 110 causes a mixing of the components in the mixing tank 110. Diverting excess chlorinated solution via return lines 112 to the mixing tank 110 ensures enough velocity inside the mixing tank 110 to prevent accumulation of, for example, calcium carbonate or other solids precipitating from the chlorinated solution. Optionally, either replacing the function of the water pumps 144 and return lines 112, or in addition thereto, the mixing tank 110 can include a mechanical agitator.

Mixing tank 110 can include an optional level sensor 154 that generates a signal indicative of the water level therein. This signal is relayed to PLC 104 which in turn generates a control signal to control the operation of flow control valve 102 to maintain a desired liquid level in mixing tank 110. Mixing tank 110 is sized to allow time for even mixing of the chlorinated and acidified subfractions of chlorination stream BB before allowing it to exit as mixed water stream CC.

Mixed water stream CC is directed from mixing tank 110 through pumps 144. A small portion of mixed water stream CC can be diverted to a sampling cell 156, or directly to a chlorine analyzer (not shown). The chlorine analyzer and/or the sampling cell 156 can sense the chlorine level (ppm) of mixed water stream CC and transmit a signal indicative of this level to PLC 104, it can also be used to monitor the level of chlorine introduced into tank 200 (not shown). PLC 104 in turn generates a control signal operate metering control valve 124 to control the fraction of flow AA that passes through bypass line 106 to maintain mixed water stream CC at a desired chlorine concentration.

A pH analyzer 126 can sense the pH of chlorinated water stream BB in mixing tank 110, in the acidified make up water line 102, and in the chlorination tank 200. The pH analyzer 126 communicates this information to PLC 104. PLC 104 regulates a booster pump (not shown) and/or control valve 124 such that the volume of acid from the acidified make up water stream AA is controlled to maintain the desired pH of the solution on the chlorination tank 200 and in the mixing tank 110 and to maintain the hypochlorous acid stream CC in the range of about 5.5 to about 7, resulting in an increase in HOCl concentration compared to OCl⁻ concentration in mixing tank 110 (i.e., the ratio of HOCl to OCl⁻ is greater than one). Hypochlorous acid stream CC preferably contains about 77 to about 99 percent hypochlorous acid at ambient temperature.

Hypochlorous acid stream BB then enters mixing tank 110 before injection into one or more target liquid stream(s) CC via line(s) 142. Pumps 144 move streams CC out of line 142 optionally to a wash water line or a chiller, or to the return line 112, as discussed above. In one embodiment, streams CC are maintained at a pressure of at least about 50 pounds per square inch gauge (psig). One pump or more than one pump can be used. In an exemplary embodiment, the pump(s) are centrifugal pumps providing constant flow distribution from the mixing tank 110 to the desired location.

The pH analyzer 126 is provided to sense the pH of target liquid stream EE downstream of the point at which the acidified chlorinated carrier water is injected and to provide a signal indicative of the sensed pH to PLC 104. PLC 104 then adjusts the flow rate of the acidified make up water line AA through control valve 124 to control the amount of acid being introduced and thereby maintain the pH of the chlorinated solution in the mixing tank 110 at a desired setpoint for efficient chlorination as discussed above. Alternatively, the system can be controlled in a manual mode as well as PLC controlled.

As previously mentioned, in the treated water solution, HOCl and OCl⁻ are generally present in a pH dependent equilibrium:
HOCl [symbol] H⁺+OCl⁻ pKa=7.53

As shown in Table 1, at low pH, HOCl is the predominant form, while at high pH, OCl⁻ predominates:

TABLE 1
Percent HOCl

| | Temp ° C. | | | | | | |
|---|---|---|---|---|---|---|---|
| pH | 0 | 5 | 10 | 15 | 20 | 25 | 30 |
| 5.0 | 99.85 | 99.83 | 99.80 | 99.77 | 99.74 | 99.71 | 99.68 |
| 5.5 | 99.53 | 99.75 | 99.36 | 99.27 | 99.18 | 99.09 | 99.01 |
| 6.0 | 98.53 | 98.28 | 98.01 | 97.73 | 97.45 | 97.18 | 96.92 |
| 7.0 | 87.05 | 85.08 | 83.11 | 81.17 | 79.23 | 77.53 | 75.90 |
| 8.0 | 40.19 | 36.32 | 32.98 | 30.12 | 27.62 | 25.65 | 23.95 |
| 9.0 | 6.30 | 5.40 | 4.69 | 4.13 | 3.68 | 3.34 | 3.05 |
| 10.0 | 0.67 | 0.57 | 0.49 | 0.43 | 0.38 | 0.34 | 0.31 |
| 11.0 | 0.067 | 0.057 | 0.049 | 0.043 | 0.038 | 0.034 | 0.031 |

The HOCl is much more effective than OCl⁻ for killing microorganisms because HOCl is nonpolar and can cross the outer membrane of most microbes and bacteria. In order for HOCl, which is more effective than OCl⁻ for killing microorganisms, to be the predominant form in the chlorinated water, it is desirable to maintain an acidic pH for the chlorinated solution. Therefore, it is desirable to control the pH of the treated water solution to between 5.5 and 7.0 in order to ensure almost complete (˜98%) conversion to the hypochlorous acid form and thereby increase the antimicrobial effectiveness of the chlorination of the target liquid stream. At a pH of about 5.5 or lower, chlorine gas evolves from the solution. Therefore, in one embodiment, the pH of the solution stream is greater than about 5.5 to about 7.

In order to reduce the formation of OCl⁻ ions, the pH of the solution in the chlorination tank 200 can be less than about 6.5, or about 5.8-6.2, or about 6.0. In order to reduce the formation of OCl⁻ ions, the chlorinated solution in the mixing tank 110 be about 5.5 to about 7, or about 6.8 to about 7. The predetermined pH is accomplished by introducing an amount of acidified make up water from stream AA sufficient to achieve the desired pH.

The acid used to form the acidified make up water of stream AA can be organic or inorganic. Suitable organic acids include for example, but not limited to, carbonic acid, formic acid, acetic acid, citric acid, lactic acid, trifluoroacetic acid, oxalic acid, tartaric acid, fumaric acid, maleic acid, methanesulfonic acid, benzenesulfonic acid and p-toluenesulfonic acid. Suitable inorganic acids include for example, but are not limited to, hydrochloric acid, hydrobromic acid, sulfuric acid, nitric acid and phosphoric acid. It has been found that with carbonic acid, in particular, the ability to achieve a pH less than 5.5 is greatly reduced, thus reducing the risk of evolution of chlorine gas from the chlorinated solution. An exemplary system for providing carbonic acid solution as the acidified make up water stream AA is that disclosed in U.S. Pat. No. 5,487,835 to Shane, which is incorporated by reference as if fully set forth herein. In an exemplary embodiment, the system of the present patent application is used to provide carbonic acid solution having a pH of less than 7 and greater than about 5.5, preferably having a pH in the 5.5 to about 6.5, more preferably about 5.6 to about 5.8.

It should be noted particularly with respect to using carbonic acid as the acid for acidifying the chlorinated water, that calcium carbonate (CaCO₃) precipitate may be formed. As a strong base such as the hypochlorite solution is added to the H₂CO₃, it reacts to form water and HCO₃⁻, the bicarbonate ion. The pK of carbonic acid is 6.3. Therefore, a pH of 6.3 represents the middle of the first “buffer range” of this acid. If the strong hypochlorite base is added to excess after all of the carbonic acid has been converted to bicarbonate ion, the HCO₃⁻ reacts with the hypochlorite ion to form water and a carbonate ion, CO₃⁻². The ion can react with the dissociated Ca⁺² ions to form CaCO₃, which can precipitate out of solution. Precipitation of insoluble CaCO₃ or other particles can clog the mixing tank 110 and water lines 142. As noted previously, the use of a high velocity water stream CC returning to the mixing tank 110 via return lines 112 can prevent the accumulation of carbonate precipitate, or any other solids formed, in the mixing tank 110 and water lines 142.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and protected by the following claims.

1. A method for dissolving chlorine in water to form hypochlorous acid in a chlorination system, the method comprising the steps of:
introducing an acid solution into a chlorinating tank, the acid solution having a pH of less than 7 and greater than about 5.5;
combining the acid solution with a chlorinating agent to form a hypochlorous acid solution;
controlling the amount of the acid solution introduced into the chlorinating tank to bring the pH of the combined hypochlorous acid solution to less than about 6.5; and
preventing the accumulation of precipitates in the chlorination system.

2. The method of claim 1, wherein the chlorinating agent is selected from the group consisting of chlorine gas, metal hypochlorites, isocyanuric acid, and mixtures thereof.

3. The method of claim 1, wherein the chlorinating agent is chosen from sodium hypochlorite and calcium hypochlorite.

4. The method of claim 1, wherein the acid solution comprises an organic acid.

5. The method of claim 4, wherein the organic acid is chosen from the at least one of carbonic acid, formic acid, acetic acid, citric acid, lactic acid, trifluoroacetic acid, oxalic acid, tartaric acid, fumaric acid, maleic acid, methanesulfonic acid, benezenesulfonic acid, p-toluenesulfonic acid, and mixtures thereof.

6. The method of claim 4, wherein the organic acid is carbonic acid.

7. The method of claim 1, wherein the acid solution comprises an inorganic acid.

8. The method of claim 6, wherein the inorganic acid is chosen from hydrochloric acid, hydrobromic acid, sulfuric acid, nitric acid, phosphoric acid, and mixtures thereof.

9. The method of claim 1, further comprising the step of delivering the hypochlorous acid solution from the chlorinating tank to a mixing tank.

10. A method for dissolving chlorine in water to form hypochlorous acid in a chlorination system, the method comprising the steps of:
introducing an acid solution into a chlorinating tank, the acid solution having a pH of less than 7 and greater than about 5.5;
combining the acid solution with a chlorinating agent to form a hypochlorous acid solution;
controlling the amount of the acid solution introduced into the chlorinating tank to bring the pH of the combined hypochlorous acid solution to less than about 6.5;
delivering the hypochlorous acid solution from the chlorinating tank to a mixing tank;
removing the hypochlorous acid solution from the mixing tank under pressure;
delivering a portion of the hypochlorous acid solution to a desired location under pressure;
returning a portion of the hypochlorous acid solution to the mixing tank under pressure; and
mixing within the mixing tank the hypochlorous acid solution delivered from the chlorinating tank and the portion of the hypochlorous acid solution returned to the mixing tank under pressure.

11. The method of claim 10, further comprising removing the hypochlorous acid solution from the mixing tank by a constant flow distribution pump.

12. The method of claim 10, wherein the pressure is at least about 50 psig.

13. The method of claim 1, further comprising
monitoring the pH of the combined hypochlorous acid solution via a control system; and
controlling the amount of at least one of the chlorinating agent and the acid solution introduced into the chlorinating tank.

14. The method of claim 1, further comprising the steps of:
monitoring the pH of the combined hypochlorous acid solution via a control system; and
controlling the amount of both the hypochlorite and the acid solution being introduced into the chlorinating tank.

15. The method of claim 14, wherein the control system includes separate control valves for controlling the introduction of the acid solution into the chlorination system and for controlling the amount of the hypochlorous acid solution returned to the mixing tank.

16. The method of claim 1, wherein controlling the amount of the acid solution introduced into the chlorinating tank comprises controlling the amount of the acid solution to bring the pH of the combined hypochlorous acid solution to a range about 5.8 to about 6.2.

17. A method for dissolving chlorine in water to form hypochlorous acid in a chlorination system, the method comprising the steps of:
introducing an acid solution into a chlorinating tank, the acid solution having a pH of less than 7 and greater than about 5.5;
combining the acid solution with a chlorinating agent to form a hypochlorous acid solution;
controlling the amount of the acid solution to bring the pH of the combined hypochlorous acid solution to a range about 6.8 to about 7.0; and
preventing the accumulation of solids in the chlorination system.

18. A system for introducing hypochlorous acid to a fluid stream, the system comprising:
a line configured to deliver acid solution into a chlorinating tank, the acid solution having a pH of less than 7 and greater than about 5.5;
a chlorinating tank, wherein the acid solution is combined with a chlorinating agent disposed in the chlorinating tank to form a hypochlorous acid solution; and
a control system configured to control the amount of the acid solution introduced into the chlorination system to bring the pH of the combined hypochlorite/acid solution to less than about 6.5.

19. The system of claim 18, wherein the acid solution comprises carbonic acid.

20. The system of claim 18, further comprising:
a line configured to deliver the hypochlorous acid solution from the chlorinating tank to a mixing tank;
a line configured to remove the hypochlorous acid solution from the mixing tank under pressure;
a line configured to deliver a portion of the hypochlorous acid to a desired location under pressure;
a line configured to return a portion of the hypochlorous acid solution to the mixing tank solution through a constant flow distribution pump and under a pressure of about 50 psig, wherein the hypochlorous acid solution delivered from the chlorinating tank is mixed with the portion of the hypochlorous acid solution returned to the mixing tank under pressure.
